(19) United States
(12) Patent Application Publication
(10) Pub. No.: US 2020/0188906 A1
(43) Pub. Date: Jun. 18, 2020

(54) CONTAINER FOR A FILTRATION ASSEMBLY

(71) Applicant: Siemens Healthcare Diagnostics Inc., Tarrytown, NY (US)

(72) Inventor: Claus Tuma, Lauf an der Pegnitz (DE)

(73) Assignee: Siemens Healthcare Diagnostics Inc., Tarrytown, NY (US)

(21) Appl. No.: 16/495,269

(22) PCT Filed: Feb. 18, 2017
(86) PCT No.: PCT/US2017/018535

§ 371 Date: Sep. 18, 2019

Related U.S. Application Data
(60) Provisional application No. 62/296,667, filed on Feb. 18, 2016.

(51) Int. Cl. B01L 3/00; B01L 9/00; B01D 63/08; B01D 69/10; B01D 71/50; B01D 61/14

(52) U.S. Cl. CPC B01L 3/508; B01L 9/00; B01D 63/087; B01D 69/10; B01D 71/50; B01L 2300/0681; B01L 2200/025; B01L 2300/0858; B01L 2300/041; B01L 2300/06; B01D 61/147

(57) ABSTRACT

The invention relates to a container for a rack of a diagnostic robot comprising: —a container body comprising a sidewall or multiple sidewalls, a bottom and a top wherein the container body is of round, oval, square, rectangular, hexagonal or polygonal cross sectional shape, —the top is provided with an opening that matches the size and form of a filter membrane/supporting body of an object carrier which is placed over the opening in the top of the container for filtration of a sample, wherein the opening exhibits a rim and —the top is provided with a top-guiding-means which matches with a corresponding object-carrier-guiding-means on or in the object carrier so that the object carrier locks with a predetermined surface faced up into a predetermined position on the top and —the container is equipped with an adapter which matches a gas outlet on the rack.

### CROSS-REFERENCE TO RELATED APPLICATIONS

This application claims priority of U.S. Provisional Application No. 62/296,667, filed Feb. 18, 2016.

### FIELD

The present invention generally relates to a container for a filtration assembly, wherein the filtration assembly comprises at least a carrier, a filter membrane and a supporting body. The filtration assembly preferably is the one described in US 2012/0315664, the disclosure of which is incorporated herein by reference in its entirety.

### BACKGROUND

Microscopy is a widely used method in analysis. In particular in the field of “life sciences”, it is an indispensable tool in order, for example, to characterize tissue and cells. Object carriers have become the established “interface” between the medium to be examined and the imaging components of a microscope. These are glass plates measuring 26×76 mm (ISO 8255-2) with a thickness of from 1 to 1.5 mm. The objects are, for example, applied to the object carrier in a thin layer and can be covered with a cover glass, which, as a rule, measures 18×18 mm and is 0.16 mm thick. Objects are, for example, sections of tissue surrounded by a film of liquid.

Filtration is also a widely used technique, in particular for separating solids of different sizes from each other and/or from liquids. When microscopy and filtration are combined, following the filtration process, the filtration residue can be examined microscopically.

To enable this process to be used routinely and inexpensively for medical diagnosis, for example during the examination of tumor cells filtered from a blood sample (see e.g. US-A-2012/021435 or US-A-2014/0110349), it is necessary to provide a simple and inexpensive solution, which can also be carried out by untrained personnel. Minimization of manual process steps also results in an improved potential for standardization and the avoidance of any impairment of the quality of the results.

US-A-2012/0315664 describes an improved assembly and method for the filtration of liquids. The assembly comprises a carrier, a filter membrane and a supporting body. The supporting body is arranged and/or formed in a recess of the carrier. The filter membrane is arranged evenly and/or flat on the supporting body.

The carrier typically is an object carrier, in particular for microscopy, which is made of glass or plastic, in particular polycarbonate. The supporting body can be textured, in particular porous. The texture determines the number of support points for the filter membrane and enables filtered liquid to drain off after passing through the filter membrane. The supporting body, likewise, can be made of plastic, in particular polycarbonate, or of a ceramic. The use of an object carrier as a carrier for the filter membrane facilitates simple handling and use in standard devices.

For filtration the object carrier is placed over a lid of a container so that the filter membrane/supporting body matches with a corresponding opening in the lid such that the gap between the object carrier and the opening in the lid is air sealed. The container is connected to tubes supplying the container with a gas at operator controlled super- and sub-atmospheric pressure, thereby allowing control of the filtration process as described e.g. in US-A-2014/0110349.

Typically, the container is a replaceable part of a rack. The rack can be placed in a diagnostic robot, e.g. a pipette robot which performs automated procedures such as pipetting one or more liquids from one or more reservoirs onto the object carrier which is reversibly fixed on the container lid. The object carrier and/or the container may then be transferred to an analyzing station inside or outside the robot.

The filtration assembly as described in US-A-2012/0315664 is manually placed over the lid of the container. Since the arrangement of the supporting body and the membrane in the object carrier are such that the filtration can only be performed in one direction from the membrane side to the supporting body side of the object carrier, it is critical to place the assembly with its membrane side up onto the lid of the container. Once the filtration assembly has been placed onto the lid of the container the container including the filtration assembly is inserted into a rack where the container is manually attached to pressure/vacuum tubes provided by the robot. Typical robots provide the pressure and the vacuum at different but constant pressure levels—one level for the super and one level for the sub atmospheric pressure.

Thus, it is apparent that the above described procedure still requires a high degree of manual labor and skills, besides that there is still a great risk that the operator places the filtration assembly with the wrong side up onto the lid of the container.

It was, therefore an object of the present invention to provide for an improved container for use in a rack of a pipette robot which rack provides utilities, i.e. at least a gas, preferably air at pre-defined but adjustable pressure levels to the container and, thus, to a filtration assembly comprising a carrier, a filter membrane and a supporting body. Moreover, the container should be designed to be used routinely and inexpensively for medical diagnosis, for example for the examination of tumor cells filtered from a blood sample. Accordingly, it was an object to develop a simple and inexpensive device, which can also be operated by untrained personnel without jeopardizing the quality of the diagnostic results.

### SUMMARY

This object is achieved with a container (12) for a rack of a diagnostoc robot comprising:
a container body (17) comprising a sidewall or multiple sidewalls, a bottom (18) and a top (13) wherein the container body (17) is of round, oval, square, rectangular, hexagonal or polygonal cross sectional shape,
wherein the top (13) is provided with an opening (14) that matches the size and form of a filter membrane/supporting body (2, 3) of an object carrier (1) which is placed over the opening (14) in the top (13) of the container for filtration of a sample, wherein the opening (14) exhibits a rim (19), and further
wherein the top (13) is provided with a top-guiding-means (20) which matches with a corresponding object-carrier-guiding-means (21) on or in the object carrier (1) so that the object carrier (1) locks with a predetermined surface faced up into a predetermined position on the top (13) and further
wherein the container (12) is equipped with an adapter (15) which matches a gas outlet (16) on the rack.

Advantageous embodiments of the device according to the invention and its use may be derived from the respective dependent claims. The features of the main claim can be combined with the features of one or more dependent claims and the features of the dependent claims can be combined with features from other dependent claims.

### BRIEF DESCRIPTION OF THE DRAWINGS

Preferred embodiments of the invention with advantageous developments according to the features of the dependent claims are explained in more detail below with reference to the figures, but without being restricted thereto.

The figures show:

FIG. 1 a schematic representation of an object carrier including the filtration assembly in top view with a carrier, a supporting body and a filter membrane (not part of the present invention)

FIG. 2 a schematic sectional view through the assembly shown in FIG. 1 (not part of the present invention)

FIG. 3 a perspective view of a container

FIG. 4 a 3D picture of an embodiment of the rack with 4 containers inserted

### DETAILED DESCRIPTION OF THE INVENTION

A “rack” is a standardized insert device for diagnostic robots which meets the size limitations set by the diagnostic robot, preferably by diagnostic robots from different manufacturers so that it can be used independently from the manufacturer of the given diagnostic robot. It fits the guide rail system of the inside of the robot (if present) so that it can be transferred to different preselected diagnostic stations within the robot. If necessary, the rack can be connected or is automatically connected upon insertion into the robot to utilities provided by the robot, such as electric power, digital and/or analog data input/output, fluids, gases etc. Racks can be provided for example for analytic test tubes, well plates or even hold complete diagnostic analytical devices.

### The Filtration System

The object carrier including the filtration assembly is described in detail in US-A-2012/0315664, and comprises a carrier, a filter membrane and a supporting body. The supporting body is arranged and/or formed in a recess of the carrier. The filter membrane is arranged evenly and/or flat on the supporting body.

During filtering, the supporting body provides mechanical support for the filter membrane, thus enabling large quantities of liquid to be filtered in a reasonable time. Filter membranes, which can only be embodied as very thin, are, for example, filter membranes produced by particle bombardment from films with precisely defined through-pores or holes. Good support with the aid of the supporting body in the form of numerous, uniformly distributed support points is essential for the use of filter membranes of this kind as filters.

The carrier can have a thickness in the region of 1 to 1.5 mm, a length in the region of 75 to 76 mm and a width in the region of 25 to 26 mm. The filter membrane can have a thickness in the region of 1 to 20 μm, preferably in the region of 10 μm, and a diameter in the region of 25 mm. These dimensions make the carriers suitable for use in the most commonly used holdings in standard devices for object carriers.

The recess in the carrier can have the same size as the supporting body. This facilitates good holding of the supporting body in the carrier. On the other hand the supporting body can be produced integrally from the carrier material. In the second case, a permanently stable assembly is achieved. The supporting body can have a circular design and the filter membrane can also have a circular design. This facilitates use in systems with circular feed pipes and circular discharge pipes for fluids. A round embodiment also facilitates microscopy, because the entire circular region can be optically resolved in the microscope's field of view.

The supporting body can comprise channels formed on a side facing the filter membrane, which are in fluidic contact with the filter membrane. These channels facilitate good drainage of the filtered liquid from the filter membrane and hence good passage of liquid to be filtered through the filter membrane.

The filter membrane can be a track etched filter membrane made of polycarbonate film and comprises holes with a diameter of micrometers, in particular 8 μm and a hole density of 1% to 80% (as the ratio of the perforated area to the overall area), in particular a hole density of 105 holes per square centimeter.

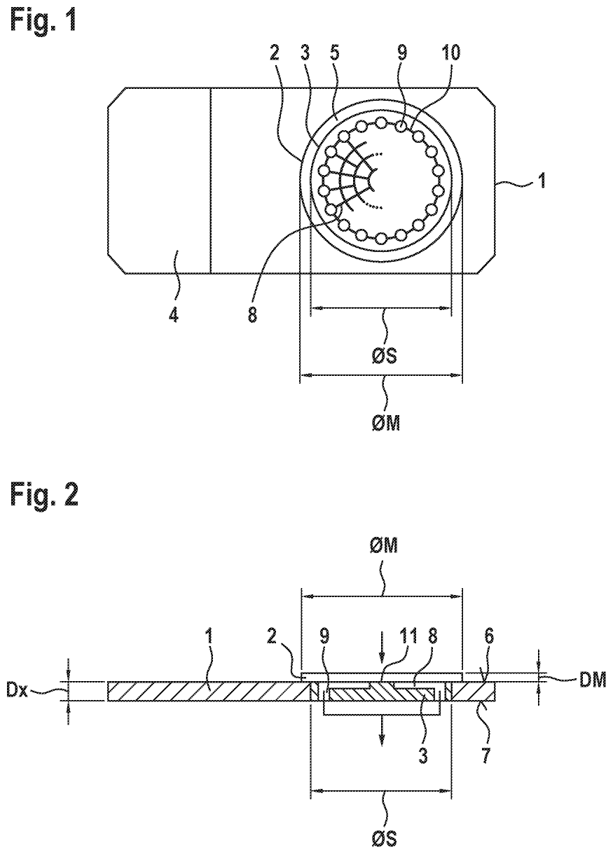

The assembly shown in FIG. 1 comprises a carrier (1) and a supporting body (3) arranged in a recess of the carrier (1). The carrier (1) is embodied as even in the form of an object carrier for light microscopy. In a region disposed at a distance from supporting body (3), an area can be embodied as a grip (4) in that the surface is roughened, for example, in this region.

As FIGS. 1 and 2 show, a circular, film-type filter membrane (2) is arranged evenly on a front side (6) of the carrier (1) and the supporting body (3). The circular filter membrane (2) has, for example, a circular diameter ØM in the region of 25 mm and a thickness DM in the region of 10 μm. In the edge region (5), the filter membrane (2) is mechanically connected to the carrier, for example by welding or adhesion. The circular supporting body (3) is arranged below the filter membrane (2). The supporting body has, for example, a circular diameter ØS in the region of 23 mm and a thickness Dx corresponding to the thickness of the carrier. The filter membrane (2) lies evenly on the supporting body (3), wherein deviations from a planar contact surface between the supporting body (3) and filter membrane (2) can be, for example, maximum 100 μm. The supporting body (3) and the carrier (1) can be formed as one integral piece or the circular supporting body (3) can be arranged in a circular recess passing right through the thickness Dx of the carrier, in particular connected in a mechanically stable way to the carrier (1). In addition to circular shapes of the supporting body (3) and the recess, other shapes, for example rectangular or triangular shapes, are possible. A positive contact between the supporting body (3) and the recess of the carrier (1) is of advantage here.

As shown in FIGS. 1 and 2, channels (8) are formed in the surface of the supporting body (3) on a front side (6). In order to keep the channel density of the channels (8) on the surface in the direction of edge region (5) substantially constant, the number of channels (8) increases in the direction of the edge (5) going from the mid-point (11).

Drainage holes (9) passing completely through the thickness Dx of the carrier (1) or supporting body (3) are arranged close to the edge region (5) of the filter membrane (2) in the supporting body (3) or in the carrier (1) or in the contact region between the supporting body (3) and carrier (1). The channels (8) end in the drainage holes (9). Fluid flowing through the filter membrane (2) can come through the channels (8) and the drainage holes (9) from the front side (6) of the carrier (1) and arrive at the rear side (7) of the carrier (1) and be transported away from there. Good uniform passage through filter membrane (2) and good filtering of the fluid are facilitated. In particular, a uniform pressure drop over the entire filter membrane surface is achieved.

Alternatively, if ceramic is used as the material for the supporting body (3), a porous layer can be formed on the surface of the supporting body (3), which, similarly to channels (8) or (10), permits uniform drainage of a fluid. If the supporting body (3) is completely made of a porous material, the drainage holes (9) and channels (8) or (10) can be provided by the porosity.

In order to place the filtration assembly (the object carrier) with its correct surface facing up onto the container top (13) for filtration, the carrier (1) is provided with object-carrier-guiding means (21) which match with corresponding top-guiding-means (20) on the container top (13). For example, the object-carrier-guiding-means (21) can have the form of elevations in the container top (13) and matching depressions in object carrier (1) or vice versa or pairs of an elevation and a depression in the container top (13) matching with a corresponding elevation/depression pair in the object carrier (1). The elevations/depressions can be of any form, like round, oval, square, rectangular, hexagonal or polygonal. Their size (cross-section, height/depth) is not critical but must be appropriate to withstand the mechanical stress during placement of the carrier on the top of the container and during operation. For a typical microscopy object carrier elevation/depression sizes of 0.5 to 3 mm in cross-section and 0.1 to 3 mm in height are sufficient. Preferably the elevations/depressions are of the same material as the carrier

### The Container

The container's main object is to receive the filtrate leaving the rear side (7) of the carrier (1) and to provide a stable support for the filtration assembly holding it in a fixed, predetermined position so that it can reliably be accessed by the various tools of the robot. It can in principal have any cross sectional shape, like round, oval, square, rectangular, hexagonal or even polygonal, however it seems that a round cross sectional shape (i.e. cylindrical or cone shaped) is the most economic and useful shape, which is, therefore, preferred. Likewise it can be made of nearly any material, the only restriction would be for material which could interfere with the filtrate if the filtrate is of analytical interest or is so reactive that it could destroy the container wall and, thus, contaminate the robot. Most common materials used are polyethylene, polypropylene, polyamide, polycarbonate, polystyrene and the like or glass or ceramic or metal, like stainless steel.

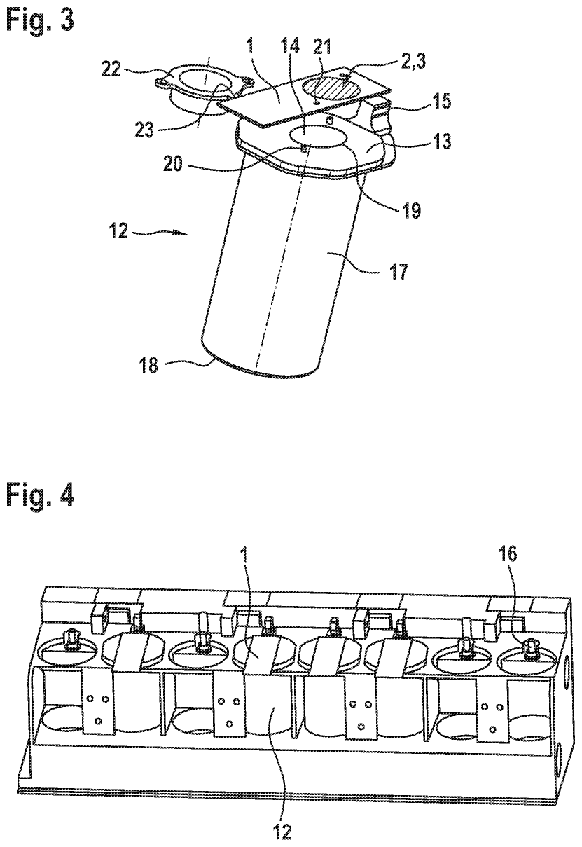

FIG. 3 shows the container (12) for a rack of a diagnostic robot comprising: a container (12) with top (13) and object carrier (1) in place. In order to provide a stable support for the filtration assembly and in order to hold it in a fixed, predetermined position the container (12) should be designed to lock into a predetermined position once placed in the rack. This can be achieved for example with a protrusion/notch system (not shown) where e.g. the protrusion is located at the rack-site and the notch on the container wall (or vice versa), so that the container only slides into its correct position when the protrusion matches the notch. Other systems that can be implemented for this purpose are a bayonet lock system or a guide rail system e.g. with vertical or spiral grooves (not shown).

The container (12) comprises a container body (17) comprising a sidewall or multiple sidewalls, a bottom (18) and a top (13) wherein the container body (17) is of round, oval, square, rectangular, hexagonal or polygonal cross sectional shape. The top (13) can be designed as an integral part of the container (12) as a unit of container body (17), bottom (18) and top (13) in which case the top (13) is preferably welded to the container body (17), but it can also be designed as a separate part (a lid) which removably covers the container (12). In the latter embodiment the top (13) is preferably provided with a seal against and around a rim formed at the top end of the container body (17) (opposite the bottom) (not shown). The top (13) is further provided with an opening (14) that matches the size and form of the filter membrane/supporting body (2, 3) of the object carrier (1) which is placed over the opening (14) in the top (13) of the container (12) for filtration of a sample. The gap between the object carrier and the opening (14) in the top (13) preferably is air sealed which can be established with an appropriate flexible ring (not shown) which is fixed on the rim (19) of the opening (14) or which is an integral part of top (13).

In order to lock the object carrier (1) with a predetermined surface faced up into a predetermined position on the top (13) the top (13) is provided with a top-guiding-means (20) which matches with a corresponding object-carrier-guiding-means (21) on or in the object carrier (1). For example, the top-guiding-means (20) can have the form of elevations in the container top (13) and matching depressions in the object carrier (1) or vice versa or at least one pair of an elevation and a depression in the container top (13) matching with at least one corresponding elevation/depression pair in the object carrier (1). The elevations/depressions can be of any form, like round, oval, square, rectangular, hexagonal or polygonal. Their size (cross-section, height/depth) is not critical but must be appropriate to withstand the mechanical stress during placement of the carrier on the top of the container and during operation. For a typical microscopy object carrier elevation/depression sizes of 0.5 to 3 mm in cross-section and 0.1 to 3 mm in height are sufficient. Preferably the elevations/depressions are of the same material as the top (13).

The container (12) is equipped with an adapter (15) which matches an outlet (16) on the rack for a gas, preferably air, at a pre-defined, adjustable pressure level. The adapter (15)/outlet (16) pair can e.g. be designed as needle/diaphragm, CPC coupling, bayonet coupling or the like (not shown). The location of the adapter (15)/outlet (16) pair is not critical but should preferably be in an area where the risk of contamination with filter products is minimal, e.g. on the upper part of the container body (17) (with the matching outlet (16) on the rack being positioned so as to match with the adapter (15) on the container (12)).

Preferably, the container (12) is further equipped with a removable funnel/fixture (22) which prevents an inadvertent displacement of the object carrier (1) and which can at the same time serve as a funnel-like reservoir for the to be filtered medium. The cross-section and form of the funnel/fixture (22) is preferably adapted to the cross-section and form of the supporting body (3) and filter membrane (2) in the object carrier (1). The height of the funnel/fixture (22) is not critical and should be adapted to typical volumes of the to be filtered medium. Typical useful volumes are 0.5 to 2 cm³, preferably about 0.75 to 1.5 cm³. The funnel/fixture (22) can be made of nearly any material, the only restriction would be for material which could interfere with the to be filtered medium if the filtrate is of analytical interest or if the to be filtered medium is so reactive that it could destroy the funnel/fixture wall and, thus, contaminate the rack and/or robot. Most common materials used are polyethylene, polypropylene, polyamide, polycarbonate, polystyrene and the like. In a more preferred embodiment the funnel/fixture (22) is attached to the top (13) via a connecting band or ribbon (23) which preferably is made from the same material as the funnel/fixture, and which more preferably is an integral part of it.

### The Rack

The rack—an embodiment of which is shown in FIG. 4—provides support for one or more, preferably up to eight containers (12) e.g. for performing lysis and filtration of whole blood samples. The containers (12) hold the filtrates and the tops (13) are designed to hold an object carrier (1) each, wherein the object carrier (1) includes a filtration assembly (2, 3).

The rack provides an outlet (16) for each container for a gas, preferably air, at a pre-defined, adjustable pressure level. The form of the gas-outlet matches with a corresponding adapter (15) on the container (12) so that a gas-leak-proof connection is established between the container (12) and the rack preferably upon insertion of the container (12) into the container-support of the rack.

### Use

With the above-described containers including the described filtration assembly whole blood samples can be filtered. This separation predominantly isolates circulating rare cells with some white blood cells and no red blood cells. After isolating the cells, the cells are fixed and washed. The filtration process can be stopped (by applying super-atmospheric pressure to the container) e.g. for bio banking slides with rare cells or can be continued with automated procedures for e.g.: molecular detection of proteins by immunocytochemistry (ICC); RNA in-situ hybridization (ISH); or cytological morphology by chromogenic dye staining (H&E). Alternatively the carriers can be used to extract cellular material for other detection methods which are not automated in the given procedure, such as PCR or FISH analysis for DNA or automated immunoassays.

The method allows cells to be fixed with formaldehyde and permeabilized with detergent to help expose intracellular antigens. The method also allows series of wash steps to wash away unbound antibody and probe, blocking steps to reduce non-specific binding and incubation steps for multiple step assays. The methods further allows using DAPI (4′,6-diamidino-2-phenylindole), a fluorescent DNA stain to stain the nuclei of the cells and the application of cover media to help preserve the fluorescent intensity of the probes.

### LIST OF REFERENCE NUMBERS

(1) carrier
(2) filter membrane
(3) supporting body
(4) grip (of carrier)
(5) edge region (of filtration assembly)
(6) front side (of carrier)
(7) rear side (of carrier)
(8) channels (of filtration assembly)
(9) drainage holes (of filtration assembly)
(10) channels (of filtration assembly)
(11) mid point (of filtration assembly)
(12) container
(13) top
(14) top opening
(15) adapter (on container)
(16) pressure outlet (on rack)
(17) container body
(18) container bottom
(19) rim
(20) top-guiding-means
(21) object-carrier-guiding-means
(22) funnel/fixture
(23) ribbon

### Inventive Subject Matter (Ism)

The following is a list of the inventive subject matter (ISM):
1. A container (12) for a rack of a diagnostic robot comprising:
   a container body (17) comprising a sidewall or multiple sidewalls, a bottom (18) and a top (13) wherein the container body (17) is of round, oval, square, rectangular, hexagonal or polygonal cross sectional shape,
   wherein the top (13) is provided with an opening (14) that matches the size and form of a filter membrane/supporting body (2, 3) of an object carrier (1) which is placed over the opening (14) in the top (13) of the container for filtration of a sample, wherein the opening (14) exhibits a rim (19), and further
   wherein the top (13) is provided with a top-guiding-means (20) which matches with a corresponding object-carrier-guiding-means (21) on or in the object carrier (1) so that the object carrier (1) locks with a predetermined surface faced up into a predetermined position on the top (13) and further
   wherein the container (12) is equipped with an adapter (15) which matches a gas outlet (16) on the rack.
2. The container of ISM 1, wherein the container body (17) is of round, oval, square, rectangular, hexagonal or polygonal cross sectional shape.
3. The container of ISM 1 or 2, wherein top (13) is designed as an integral part of the container (12) as a unit of container body (17), bottom (18) and top (13), and wherein preferably the top (13) is welded to the container body (17).
4. The container of ISM 1, 2 or 3, wherein the gap between the object carrier and the opening (14) in the top (13) is air sealed, preferably with a flexible ring which is fixed on the rim (19) of the opening (14) or which is an integral part of top (13).
5. The container of one of ISM 1 to 4, wherein top (13) is provided with a top-guiding-means (20) which matches with a corresponding object-carrier-guiding-means (21) on or in the object carrier (1).
6. The container of ISM 5, wherein the top-guiding-means (20) has the form of elevations and the object-carrier-guiding-means (21) has the form of depressions or vice versa or wherein at least one pair of an elevation and a depression in the container top (13) matches with at least one corresponding elevation/depression pair in the object carrier (1).
7. The container of ISM 6, wherein the elevations and depressions are round, oval, square, rectangular, hexagonal or polygonal, and wherein preferably the elevations and depressions have a cross-section of 0.5 to 3 mm and a height/depth of 0.1 to 3 mm and wherein preferably the elevations/depressions are of the same material as the top (13).
8. The container of one of ISM 1 to 7, wherein the container (12) is further equipped with a removable funnel/fixture (22).
9. The container of ISM 8, wherein the cross-section and form of the funnel/fixture (22) is about the same as the cross-section and form of the supporting body (3) and filter membrane (2) in the object carrier (1), and wherein preferably the height of the funnel/fixture (22) is adapted to volumes of 0.5 to 2 cm³, preferably about 0.75 to 1.5 cm³, and wherein preferably the funnel/fixture (22) is made of polyethylene, polypropylene, polyamide, polycarbonate or polystyrene, and wherein preferably the funnel/fixture (22) is attached to the top (13) via a connecting band or ribbon (23) which preferably is made from the same material as the funnel/fixture, and which more preferably is an integral part of it.
10. A filtration device comprising the container according to one of ISM 1 to 10 which holds an object carrier which includes a filtration assembly comprising a filtration membrane and a supporting body
   wherein
      an adapter on the container is attached.
11. The filtration device according to ISM 10, wherein the device is placed in a rack of a diagnostic robot and is attached to a gas-outlet on the rack so that a gas leak proof connection is established between the container and the rack.
12. Use of a container according to one of the ISM 1-9 for whole blood filtration.
13. Use of a container according to one of the ISM 1-9 for the isolation of circulating rare cells.
14. Use of a container according to one of the ISM 1-9 for bio banking carriers with rare cells.
15. Use of a container according to one of the ISM 1-9 for molecular detection of proteins by immunocytochemistry (ICC); or for RNA in-situ hybridization (ISH); or for cytological morphology by chromogenic dye staining (H&E); or for PCR or FISH analysis; or for DNA immunoassays; or for automated immunoassays; or for DAPI (4′,6-diamidino-2-phenylindole) staining of cell nuclei; or for the application of cover media to help preserve the fluorescent intensity of probes.

1. A container (12) for a rack of a diagnostic robot comprising:
a container body (17) comprising a sidewall or multiple sidewalls, a bottom (18) and a top (13) wherein the container body (17) is of round, oval, square, rectangular, hexagonal or polygonal cross sectional shape,
wherein the top (13) is provided with an opening (14) that matches the size and form of a filter membrane/supporting body (2, 3) of an object carrier (1) which is placed over the opening (14) in the top (13) of the container for filtration of a sample, wherein the opening (14) exhibits a rim (19), and further
wherein the top (13) is provided with a top-guiding-means (20) which matches with a corresponding object-carrier-guiding-means (21) on or in the object carrier (1) so that the object carrier (1) locks with a predetermined surface faced up into a predetermined position on the top (13) and further
wherein the container (12) is equipped with an adapter (15) which matches a gas outlet (16) on the rack.

2. The container of claim 1, wherein the container body (17) is of round, oval, square, rectangular, hexagonal or polygonal cross sectional shape.

3. The container of claim 1, wherein top (13) is designed as an integral part of the container (12) as a unit of container body (17), bottom (18) and top (13).

4. The container of claim 1, wherein the gap between the object carrier (1) and the opening (14) in the top (13) is air sealed.

5. The container of claim 1, wherein top (13) is provided with a top-guiding-means (20) which matches with a corresponding object-carrier-guiding-means (21) on or in the object carrier (1).

6. The container of claim 5, wherein the top-guiding-means (20) has the form of elevations and the object-carrier-guiding-means (21) has the form of depressions or vice versa or wherein at least one pair of an elevation and a depression in the container top (13) matches with at least one corresponding elevation/depression pair in the object carrier (1).

7. The container of claim 6, wherein the elevations and depressions are round, oval, square, rectangular, hexagonal or polygonal, and wherein preferably the elevations and depressions have a cross-section of 0.5 to 3 mm and a height/depth of 0.1 to 3 mm and wherein preferably the elevations/depressions are of the same material as the top (13).

8. The container of claim 1, wherein the container (12) is further equipped with a removable funnel/fixture (22).

9. The container of claim 8, wherein the cross-section and form of the funnel/fixture (22) is about the same as the cross-section and form of the supporting body (3) and filter membrane (2) in the object carrier (1).

10. A filtration device comprising the container according to claim 1 which holds an object carrier (1) which includes a filtration assembly comprising a filtration membrane (2) and a supporting body (3),
wherein
an adapter (15) on the container is attached.

11. The filtration device according to claim 10, wherein the device is placed in a rack of a diagnostic robot and is attached to a gas-outlet on the rack (16) so that a gas leak proof connection is established between the container (12) and the rack.

12. Use of a container according to claim 1 for whole blood filtration.

13. Use of a container according to claim 1 for the isolation of circulating rare cells.

14. Use of a container according to claim 1 for bio banking carriers with rare cells.

15. Use of a container according to claim 1 for molecular detection of proteins by immunocytochemistry (ICC); or for RNA in-situ hybridization (ISH); or for cytological morphology by chromogenic dye staining (H&E); or for PCR or FISH analysis; or for DNA immunoassays; or for automated immunoassays; or for DAPI (4′,6-diamidino-2-phenylindole) staining of cell nuclei; or for the application of cover media to help preserve the fluorescent intensity of probes.
